(19) United States
(12) Patent Application Publication
(10) Pub. No.: US 2009/0222849 A1
(43) Pub. Date: Sep. 3, 2009

(54) Audiovisual Censoring

(76) Inventor: Mark E. Peters, Chapel Hill, NC (US)

Correspondence Address: Steven E. Bach Attorney at Law, 10 Roberts Road, Newtown Square, PA, 19073, US

(21) Appl. No.: 12/040,639

(22) Filed: Feb. 29, 2008

(51) Int. Cl. H04N 7/16

(52) U.S. Cl. 725/28

(57) ABSTRACT

A method, apparatus, and program product are provided for selectively censoring recorded program content while displaying a program. In response to a first input, a first boundary is identified. In response to a second input, a second boundary is identified. The boundaries are associated to form a boundary pair defining censored content there between. Substitute content is retrieved or created. The content between the first boundary and the second boundary is censored by displaying the substitute content in place of the censored content.

### CROSS-REFERENCE TO RELATED APPLICATIONS

This application is related to co-pending U.S. application Ser. No. 11/859,782.

### FIELD OF THE INVENTION

The invention relates to the field of audiovisual devices and more particularly to an apparatus, method and program product for selectively replacing portions of an audiovisual program.

### BACKGROUND

It is often desirable for parents to control the content of broadcast, cable, satellite, and recorded media audiovisual programming viewed by their children. To accomplish this goal, V-chips and parental control products have been developed that block transmission of shows individually selected or matching content criteria codes selected by the parent or viewer. With these products, the blocking can be overridden by entering a code into either the television or set-top box. These solutions, however, only allow a program to be blocked or viewed in its entirety. Movies and television programs are frequently given ratings to indicate the presence of potentially objectionable content. These ratings, however, only allow a potential viewer to forego a program entirely.

One alternative in the case of children is for the parents to pre-view the program and re-watch the program with the children, fast forwarding through objectionable scenes. This approach has several drawbacks. The parents must watch the program twice, once to identify objectionable scenes and again to fast forward through the objectionable scenes. Moreover, the parent must recognize the placement of the objectionable scene before reaching it in order to fast forward through the entire objectionable scene.

Additionally, many people may wish to view programs such as a television show, movie or the like without viewing specific portions of objectionable content. Such people may fast forward through objectionable content. However, this solution may diminish the enjoyment of the program. Moreover, pieces of the storyline may be missed.

### SUMMARY

According to an exemplary embodiment of the invention a method, apparatus, and program product are provided for selectively replacing program content while displaying a program. In response to a first input, a first boundary is identified. In response to a second input, a second boundary is identified. The boundaries are associated to form a boundary pair defining censored content there between. Substitute content is retrieved or created. The content between the first boundary and the second boundary is censored by displaying the substitute content in place of the censored content.

According to another embodiment of the present invention a method, apparatus, and program product are provided for displaying a program with substitute content in place of censored content. A censoring start and end point pairs and associated content or substitute content references are retrieved for a program. The program is played. In response to reaching each start point, the substitute content is displayed. After displaying the substitute content the program resumes playing at the end point. The start and end boundary point pairs may be provided on a media with the program, embedded in a data stream with the program, or downloaded through a network. Substitute content may be associated with each boundary point pair and may be provided or referenced with the boundary point pair.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of an apparatus according to an exemplary embodiment of the present invention;

FIG. 2 is a block diagram of a system according to another exemplary embodiment of the present invention;

FIG. 3 is a flow diagram showing an implementation of the invention identifying one or more pairs of a start point and an end point for censoring according to an exemplary embodiment of the invention;

FIG. 4 is a flow diagram showing an implementation of the invention identifying one or more pairs of a start point and an end point for censoring according to another exemplary embodiment of the invention;

FIG. 5 is a flow diagram showing an implementation of the invention identifying one or more pairs of a start point and an end point for censoring according to another exemplary embodiment of the invention;

FIG. 6 is a flow diagram showing an implementation of the invention identifying one or more pairs of a start point and an end point for censoring according to another exemplary embodiment of the invention;

FIG. 7 is a flow diagram showing an implementation of the invention identifying one or more pairs of a start point and an end point for censoring according to another exemplary embodiment of the invention;

FIG. 8 is a flow diagram showing an implementation of the invention identifying one or more pairs of a start point and an end point for censoring according to another exemplary embodiment of the invention;

FIG. 9 is a flow diagram showing an implementation of the invention censoring program content between identified start and end points according to an exemplary embodiment of the invention;

FIG. 10 is a flow diagram showing an implementation of the invention censoring program content between identified start and end points according to an exemplary embodiment of the invention; and

FIG. 11 is a flow diagram showing an implementation of the invention retrieving censoring information according to an exemplary embodiment of the invention.

### DETAILED DESCRIPTION

The present invention provides a method, system, apparatus and program product for selectively censoring program content. In an exemplary embodiment of the invention, a user identifies a pair of boundaries, which enclose the content to be censored. For example, while viewing a program and recording the program to a recording device, such as a set-top box, a DVR, or the like, a user determines that a particular portion of the program should be censored. The user then provides an input to a processor which may be located in the recording device, at a remote location in a distributed network, in a computer, or at another suitable location. The input may be entered through a user input device, such as a remote control unit, a keyboard, or any other suitable input device. In the example of a remote control, the input can be provided by depressing a special purpose key or any key temporarily assigned the input function.

In one or more exemplary embodiments of the invention, the user input may be provided while viewing the program in a normal play mode, in a fast forward mode, in a rewind mode, or any other mode which allows the user to ascertain the program content. While watching a program, a user can provide an input to identify one boundary of content to be censored and another input to identify the other boundary of content to be censored. In one or more exemplary embodiments one or more additional pairs of boundaries may be identified.

After identifying a start and end point pair, the user may select or create substitute content. The substitute content may comprise any combination of text, audio, still images, video, or other content suitable to provide context for the censored content. For example, if the program content to be censored shows a person being shot, the substitute content may be the text “Kapowie!”. Similarly, if the content to be censored is a sexual scene, the substitute content may be a still image of a do not disturb sign or a drawn window shade. The plain text, plain text with MP3 files, graphics files like JPG, animated GIFs, MPEGs, or the like. The substitute content may be downloaded over the Internet, created using a computer, created using a set-top box, created using a high functioning remote control, created using a program saved on the video device or retrieved or created in any other way suitable for retrieving or creating audiovisual content.

Referring now to FIG. 1, a device 100 for playing audio and/or video programs such as a set-top box, DVR, CD player, PC, or other device usable to play content to speakers and/or one or more displays is shown. The device 100 comprises a processor 130 operably associated with a memory 140 and a user interface device 120. The user interface device 110 is adapted to receive input signals 1 from a user. The user interface device may be, for example, an RF receiver adapted to receive RF signals from a remote control device. Alternatively, the user interface device 120 may be any receiver or processor capable of receiving a user input. Moreover, the user interface device 120 may be partially or fully integral with the processor 130. For example, the interface device may be a universal serial port for connecting a keyboard or mouse device to the processor 130 through a universal bus.

The processor 130 receives a signal or data stream containing program content. This signal or data stream may be, for example, a signal 2A, from a drive 110 used to read the program content from a portable memory device, such as a DVD, CD, or the like. Alternatively the signal or data stream may be a transmission signal 2B from a satellite receiver, cable connection, television broadcast, network server, or the like. In another alternative example, the signal or data stream may be a pre-recorded data signal 2C from a memory 140 internal to or accessible to the device 100. Moreover the program may be recoded to memory 140 as a program file 141 as a recorded signal or data stream 3, or the program may be recorded to another memory separate from the program of instruction or the program may be presented through the processor 130 to a display and or speakers (not shown) via a program signal 4, or both.

The processor 130 also executes a program of instruction 143 which may be stored in memory 140, which memory may also contain the program file 141 and/or censoring files 142 as shown or may be stored in a memory separate from the program file 141 and/or censoring files 142 which will be described later. The program of instruction 143 may comprise instructions for identifying one or more pairs of start and end points for censoring program content, instructions for playing a program without censored content or with substitute content, or both, as will be described in detail below.

The program of instruction 143 may include steps to define censored content which may be enabled or executed while a program is displayed. These steps may comprise: in response to a first input, identifying a first boundary; in response to a second input, identifying a second boundary; providing substitute content, and displaying the substitute content in place of the censored program content between the first boundary and the second boundary. The step of censoring the content may include marking the start and end points with metadata on a recording of the program to cause the substitute content to be displayed in place of the censored program content during replay of the program. Alternatively, the censoring step may include saving identification of the start point, end point and substitute content, such as, for example, frame numbers, time stamps, images or image digests, or other identifying attributes which can be utilized during playback to cause the censored content to be replaced by the substitute content.

The program of instruction 143 may alternatively or additionally comprise steps to recognize the start and end points during playback of a recorded program and to display substitute content in place of the censored program content (i.e., the content between the boundaries). Thus, while playing a program for which a start point and an end point for censoring are identified, the program of instruction in response to reaching the start point, starts displaying the substitute content in place of the censored program content, and in response to reaching the end point, the program of instruction resumes playing the program.

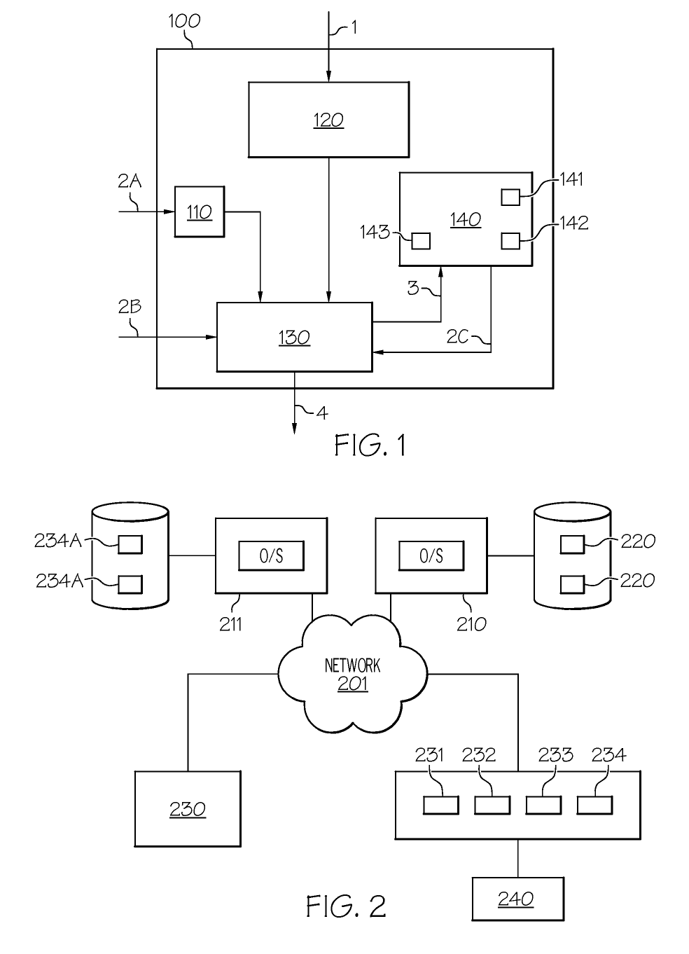

A system for displaying programs with substitute content in place of censored program content comprising a distributed network is shown in FIG. 2. In an exemplary embodiment, clients 230 are connected, through a network 201 to a program server 210 that can access and download program files 220 to the clients 230. The program files 220 may be stored on the server, or more typically will be located remotely on a storage device. A client 230 requests a specific program and the program file 220 of the requested program is downloaded by the program server 210 through the network 201 to the requesting client 230. The client 230 then presents the content of the program file 220 as a signal or data stream to a display 240 which may comprise a video display, speakers, or both.

A processor 231 is adapted to execute a program of instruction 232. The processor 231 and the program of instruction 232 may both be located in the client as shown in FIG. 2. However, either the processor 231, the program of instruction 232, or both may be located in the program server 210 or at another location remote from the client 230 and the program server 210. The processor 231 is adapted to execute the program of instructions 232 to perform the steps of: playing a program; in response to a first input, identifying a first boundary for censoring program content; in response to a second input, identifying a second boundary for censoring program content; determining which of said boundaries is a start point; receiving substitute content, and censoring the program content between the start point and the end point by displaying the substitute content in place of the censored (i.e., identified) program content.

An altered program file 233 may be saved to facilitate displaying the program with the substitute content. For example, the censored content may be deleted and the substitute content inserted in its place. Alternatively, the censored file may have metadata inserted at the start point and end point for each instance of censored content, such that the processor 231 can display an associated substitute content in place of the censored content. In still another alternate embodiment, the start point and end point may be identified by a frame number, a time stamp, or one or more images or image digests, saved on the altered program file 233. The altered program file may be saved in the client 230 as shown, or on the server or remotely.

In another exemplary embodiment, the start point and end point identifiers and/or the substitute content may be saved in a censoring file 234, which is separate from the program file 233, as shown in FIG. 2. The start point and end point identifiers may comprise frame numbers, time stamps, images or image digests. The censoring file 234 may contain one or more pairs of start point and end point identifiers. The substitute content may comprise text, images, video and/or audio content as described above. The censoring file may be located in a memory device within the client 230, as shown, or alternatively, may be located in a memory on the server or remotely. Moreover, the censoring files may be transmitted through the network 201 and shared between clients 230 to view a program with substitute content displayed in place of censored program content as identified in the censoring file 234.

In an exemplary embodiment, censoring files 234A may be collected and distributed through a network 201, such as the Internet. An organization, group or business may choose to create censoring files 234A for use by members, associates or the general public. These censoring files may be downloaded from a sever 211 to client 230 which may be for example a DVR, PC or other audiovisual processing device. Alternatively, the censoring files 234A may be downloaded to a memory device such as a flash drive, MP3 player, or the like that can be operably connected to audiovisual device 230. Thus, instead of censoring a program personally, a parent may download a censoring file 234A from a trusted source, such as a parent group or the like.

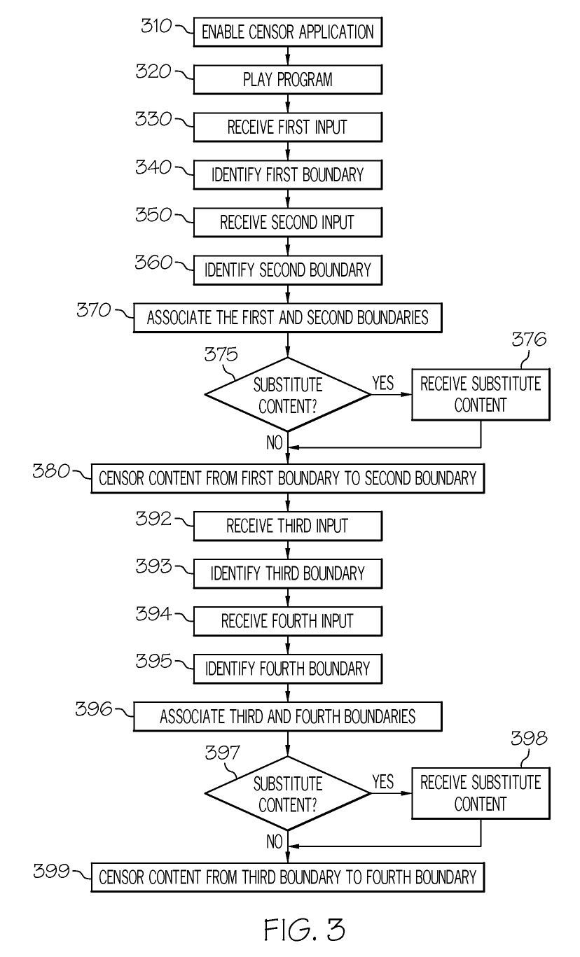

A method for censoring program content is shown in FIG. 3 according to an exemplary embodiment of the invention. In this exemplary embodiment, the method is realized in a censor application or program of instruction which is responsive to user initiated stimuli. The censor application is initiated (step 310). The application may be initiated by a command or user input applied through a remote control or the like. Alternatively, the application may be initiated as a default setting of an apparatus or system for recoding and/or playing recorded program content.

With the censor application enabled, the program is played (step 320). The program may be played for example in response to a user command or input. The program may be played in normal play mode, in fast forward mode, in rewind mode, or in any other mode which allows the user to ascertain the program content and determine any content that the user chooses to censor (i.e., that content to which the user wishes to prevent or limit access). The program can be played while it is being recorded for future use, or it can be played from a solid state memory or a memory drive, or the like.

A user provides an input at a boundary (i.e., the beginning or end) of a portion of program content to be censored. For example, while viewing and recording a program from a cable broadcast, a viewer determines that a particular portion of the content is not suitable for younger viewers who will be watching the recorded program. Accordingly, the user provides an input, such as depressing a button or key on a remote control having the censoring function assigned to it. The censoring function may be temporarily assigned by the program of instruction or the button or key may be dedicated to this function. The user provides another input at the other boundary of the content to be censored.

In an exemplary embodiment, the user identifies the boundaries in a specific order, while in another exemplary embodiment, the user may identify the boundaries in either order. That is, the user may first identify the end point. Thus, the user while viewing content determines content which the viewer desires to censor, and the user identifies a boundary when the objectionable content is completed (i.e., the end point). The user can then rewind the recorded program until the beginning of the objectionable content is reached (i.e., the start point) and identify the other boundary. It should be noted that in an exemplary embodiment the boundaries may be identified while in a normal play mode, a fast forward mode, a rewind mode, or any other mode that allows the user to ascertain the content of the program. Moreover, the censoring application may be executed while a program is simultaneously viewed and recorded or while the program is viewed from a recorded media.

The application receives a first input from the user (step 330) when the program reaches a point at which the user wishes to begin or end the censoring. In response to the first input from the user, the application identifies a first boundary (step 340). The first boundary, as described above can be the point in the program content when the censoring is to begin or the point where the censoring is to end. Also, the first boundary may be identified by a frame number corresponding to one of a sequential series of frames that are displayed in order to play a program. Alternatively, the first boundary may be identified by a time stamp, by one or more images or image digests, or by any other means that serves to differentiate a specific point in the program. In yet another alternate identification, the first boundary may be identified by inserting metadata onto the program at the boundary point.

The application receives a second input from the user (step 350) when the program reaches a point at which the user wishes to begin or end the censoring (i.e., the opposite boundary point for the censored content from the first boundary). In response to the second input from the user, the application identifies a second boundary (step 360). Together, the pair of the first and second boundaries defines the censored content between them.

In an exemplary embodiment, the first and second boundaries are associated with each other (step 370). Thus, for example, when a first boundary is identified in step 340, the application waits for a second boundary to be identified to create a pair of boundaries. In this way, the application can associate the two boundaries and determine which boundary is the start point and which boundary is the end point by comparing frame numbers, time stamps, or the like.

The user then determines whether or not to provide substitute content (step 375). If the censored content is relatively minor and will not create a gap in the storyline, the user may decide to merely skip the censored content. Conversely, if the censored content would leave a gap or provide context for the program, the user may decide to provide substitute content. In an exemplary embodiment, the user is prompted to determine whether to provide substitute content, such as by a menu or dialog box. The user may also be guided by a menu or dialog box through the task of providing the substitute content, such as through selecting from a menu of substitute content clips.

The application receives the substitute content (step 376) and associates it with the boundary point pair. In an exemplary embodiment, following selection of the second boundary point of a boundary point pair, the application prompts the user as follows:
Press A to enter a text summary of the censored content
Press B to record a voice summary of the censored content
Press C for advanced options
   Then, if the user selects A, the application captures a text message input from the remote or other input device, and saves the text as substitute content associated with the boundary pair. Optionally the text may incorporate features such as scrolling or the like. If the user selects B, the application records an audio clip and saves it as substitute content associated with the boundary pair. If the user selects C, the application prompts the user as follows:
Press A to import multimedia file or files
Press B to record a video summarizing the content
Press C to black out screen and leave audio
Press D to omit audio and preserve video
Press E to compose a smudged area
   If the user selects A, then the application may make a connection to a WEB page, for example, and prompt the user with a listing of available files. The file or files selected by the user would then be saved as substitute content associated with the boundary pair. If the user selects B, then the application may turn on camera on a set top box or an interconnected game console to make a recording as substitute content associated with the boundary pair. If the user selects C or D, the application suppresses the video or audio, respectively. If the user selects E the application provides a smudging function which the user may manipulate to an area to be smudged using directional functions for example. The video with smudges is then saved as substitute content associated with the boundary pair.

The content between the first and second boundaries is censored (step 380). The content may be censored in any manner which causes the audiovisual device to display substitute content in place of censored program content. For example, a portion of program content may be deleted after the first boundary is identified and until the second boundary is identified, or the program content between the boundaries may be deleted after the pair of boundaries are identified. Then, the substitute content may be added in place of the censored program content. The modified program may then be saved as a censored program or censored program file.

Alternatively the program content between the first and second boundaries may be censored by enabling an apparatus or system replaying the recorded program to locate the start and end point boundaries during playback and selectively display substitute content in place of the censored program content between the start point and the end point, as will be described below. The start point and end point may be located by inserting metadata on the program at the start point and the end point, the metadata being readable by the apparatus or system playing the program from memory.

In another exemplary embodiment, the start point and end point are located by saving a unique parameter of the boundary points, such as frame numbers, time stamps, or images or image digests. For example, a program that plays at 30 frames per second may have each frame identified by a unique sequential frame number. These frame numbers can be used by an application to cause an apparatus or system for playing the program to identify a particular point to begin to display a substitute content or resume displaying program content. The program content may continue to play during censored program content. However, the apparatus or system playing the program will execute an application that will override the program content in the data stream to the display, replacing it with the substitute content. Thus, censoring content between the first and second boundaries may comprise saving the frame numbers for the boundaries to be used during playback and saving the substitute content associated with each boundary point pair. Similarly, the unique parameter may be a time stamp which is saved during recording of a program to identify the time at which it was originally broadcast. The time stamps may be saved and used by the application to cause the program content between the boundaries to be selectively skipped.

Yet another unique parameter for identifying boundary points is to save an image or an image digest from one or more frames at the start and at the end of a portion of program content to be censored. An image is a digital representation of a frame or a refresh cycle from a program, and a digest of an image is a smaller digital record having less data but containing data usable for image matching such as a thumbnail with fewer pixels but the same pattern or another version of the image having less data. Images or image digests corresponding to the start point and end point for censoring can be saved. By comparing images during playback with the saved boundary images or image digests, the application can cause the program content between the boundaries to be selectively replaced by substitute content.

As illustrated in FIG. 3, the application may identify more than one pair of boundaries, thereby replacing more than one portion of program content. As shown in FIG. 3 a third input is received (step 392) from the user during play of the program corresponding to a second portion of program content to which the user wishes to prevent or limit access. As with the first censored content, the third input may correspond to either the beginning or the end of the censored content or may be a specific boundary depending upon the particular embodiment.

In response to the third input, the application identifies a third boundary point in the program content (step 393). Similarly, a fourth input is received from the user (step 394) and a fourth boundary is identified (step 395). Thus, the third and fourth boundaries comprise a second pair of boundary points identifying a second portion of program content to be censored between the boundary pair. The third and fourth boundaries are associated as a boundary pair (step 396). The application identifies whether or not substitute content will be provided (step 397) and if so, receives the substitute content (step 398). Then, program content between the boundary pair is censored (step 399).

The user may continue to provide inputs to identify boundary pairs, thereby censoring additional portions of program content. Each pair of boundaries is associated to define censored content there between. As with the program content between the first boundary pair, the content between each pair of boundaries may be censored by the application using deletion, saving boundary identification for use by an application during playback to skip or substitute the censored content, or by inserting metadata to cause the censored content to be selectively skipped or substituted.

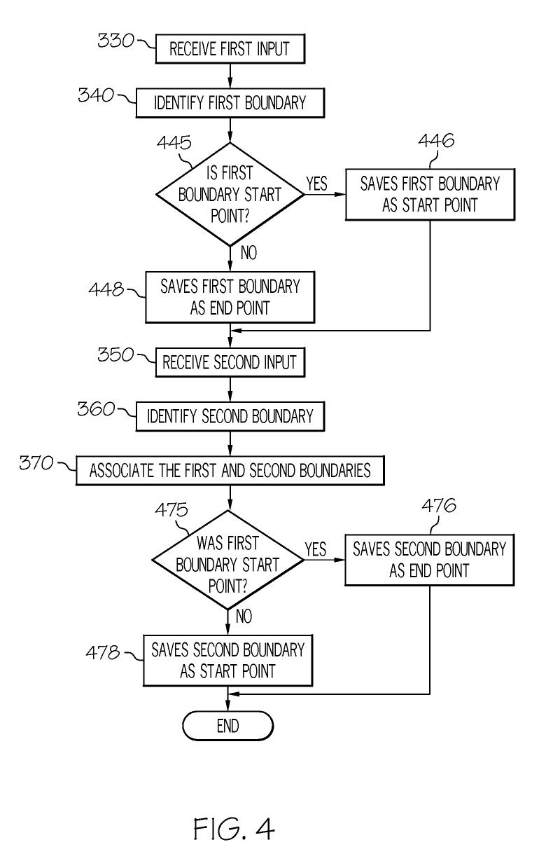

Another exemplary embodiment of the invention is shown in FIG. 4. In this embodiment, the application receives a first input from a user (step 330) who is viewing and/or listening to the program in any of a variety of play modes as in the exemplary embodiment shown in FIG. 3. In response to the first input, the application identifies a first boundary (step 340). As in earlier embodiments, the first boundary may be identified in a variety of ways, such as inserting metadata or saving a frame number, time stamp, or image or image digest.

In the exemplary embodiment illustrated in FIG. 4, the application determines whether or not the first boundary is a start point for censoring (step 445). This can be done in a variety of ways. For example, the system can query the user using a menu driven query that the user answers by moving up or down through a menu of answers (e.g., start censor and end censor) and selecting a response by depressing an enter button or key on a remote control. If the first boundary is determined to be the start point for censoring a portion of program content, the application saves the first boundary as a start point (step 446). The start point may be saved in the program content file or in a separate censoring file that may be stored and transmitted independently of the program content file. In the illustrated example the boundary is saved as a start point (step 446), however, the first boundary could alternatively be identified as a start point for censoring a portion of program content by inserting start point metadata onto the recorded program file at the first boundary.

If the application determines in step 445 that the first boundary is not a start point for censoring a portion of program content, then the first boundary is saved as an end point (step 448). As with the start point, the end point could alternatively be identified by inserting end point metadata onto the recorded program file at the first boundary.

As the user continues to view/listen to the program, the user provides a second input at the beginning/end of the program content to be censored. The application receives the second input (step 350) and, in response, identifies a second boundary (step 360). The second boundary is associated with the first boundary (step 370) to form a pair of boundaries that define censored content there between. Each portion of censored content has a beginning and an end, and therefore boundaries need to be associated into pairs, so that each pair defines a single portion of censored content.

The application determines through association of a pair of boundaries whether the first boundary in the pair was a start point (step 475). If so, then the second boundary is saved as an end point (step 476). If not, then the second boundary is saved as a start point (step 478). Thus the pair of boundaries comprises a start point and an end point for censoring. As described previously, the start point and end point may be identified by insertion of metadata rather than being saved. Also, the start point and end point may be saved as frame numbers, time stamps, or images or image digests.

Having identified a pair of boundaries and saved them as a start point and an end point, the application censors program content from the start point to the end point (step 481). This censored content may be deleted, or the content may be censored by selectively skipping it or displaying substitute content when an application recognizes the start point and resuming presentation of program content when an application recognizes the end point.

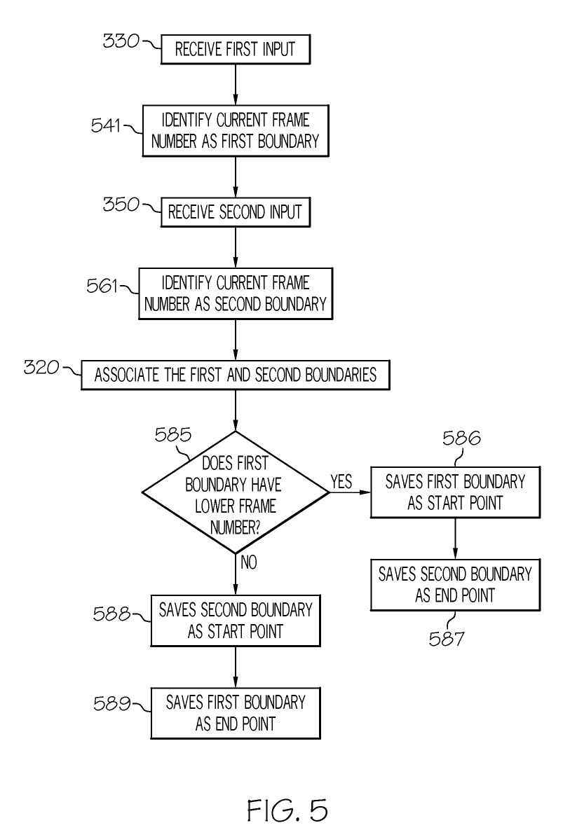

FIG. 5 illustrates an exemplary embodiment in which the boundaries are defined as frame numbers and the application determines the start point and end point by comparison of frame numbers. While a user is viewing/listening to program content, the user provides and the application receives a first input (step 330). In response to the first input, the application identifies the current frame number as a first boundary (step 541). That is, the frame number being displayed when the first input is received is captured. This frame number may be saved, for example in a censoring file or on the program content file.

The user subsequently provide a second input, and the application receives the second input (step 350). In response to the second input, the application identifies the current frame number as the second boundary (step 561). That is the frame number of the frame or screen image that is being displayed when the second input is received, is captured and the second boundary is set at this frame number. The first and second boundaries are then associated to form a pair of boundaries (step 370).

The application compares the first and second boundaries to determine which is the lower frame number (step 585). If the first boundary is the lower frame number, then the first boundary is saved as a start point (step 586) and the second boundary is saved as an end point (step 587), defining censored program content from the start point to the end point to be selectively skipped during replay. If the first boundary is not the lower frame number, then the second boundary is saved as a start point (step 588) and the first boundary is saved as an end point (step 589), defining censored program content from the start point to the end point to be selectively skipped or for which substitute content will be displayed during replay.

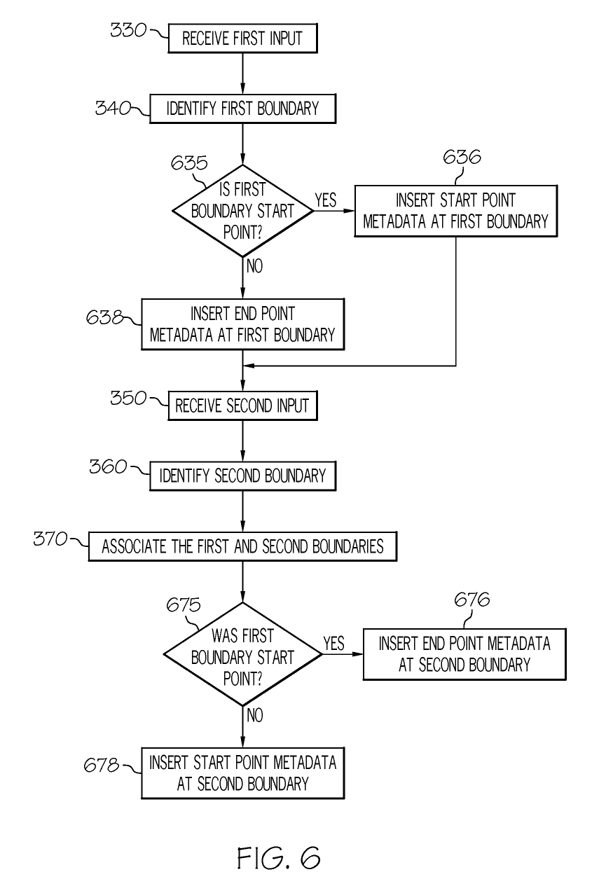

FIG. 6 illustrates an exemplary embodiment of the invention in which first and second boundaries are identified by inserting metadata onto the program content at the beginning and end of the content to be censored, and in which the start point is determined by querying the user. As with previous exemplary embodiments, the application receives a first input from the user (step 330) who is viewing/listening to the program content and determines that a portion of program content should be censored. In response to the first input, the application identifies a first boundary (step 340). In this embodiment the first boundary is identified as a point in the program content being displayed when the first input is received. The application then queries the user on whether or not the first boundary is the start point for censoring. If so, then the application inserts start point metadata at the first boundary (step 636). If not, then the application inserts end point metadata at the first boundary (step 638).

The application receives a second input (step 350). In response to the second input, the application identifies a second boundary (step 360) and associates the first and second boundaries (step 370) to form a boundary pair. The application determines whether the boundary pair already has a start point (step 675) based on the earlier determination for the first boundary. If so, then the application inserts end point meta data at the second boundary (step 676). If not, then the application inserts start point meta data at the second boundary (step 678).

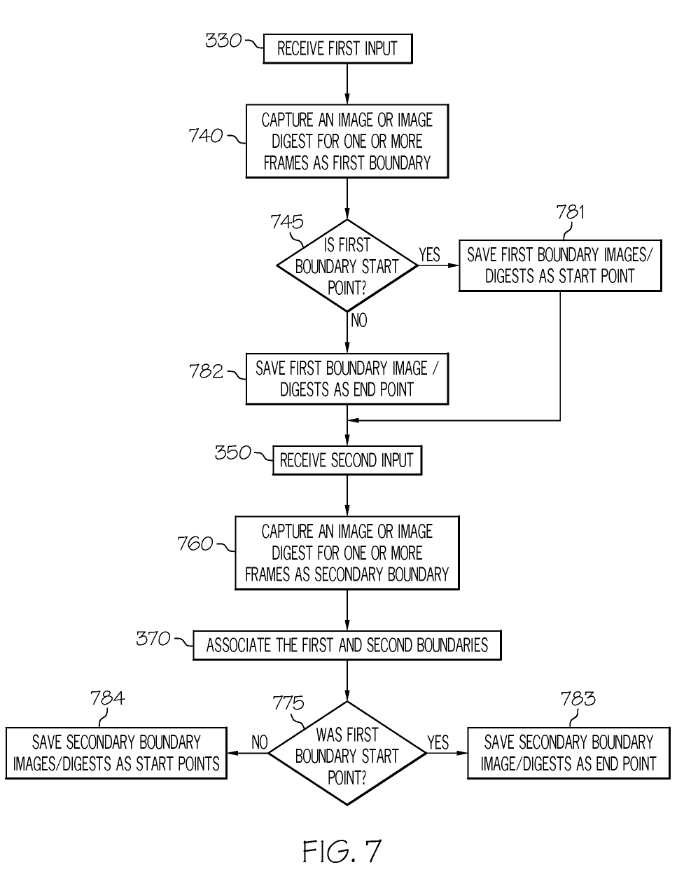

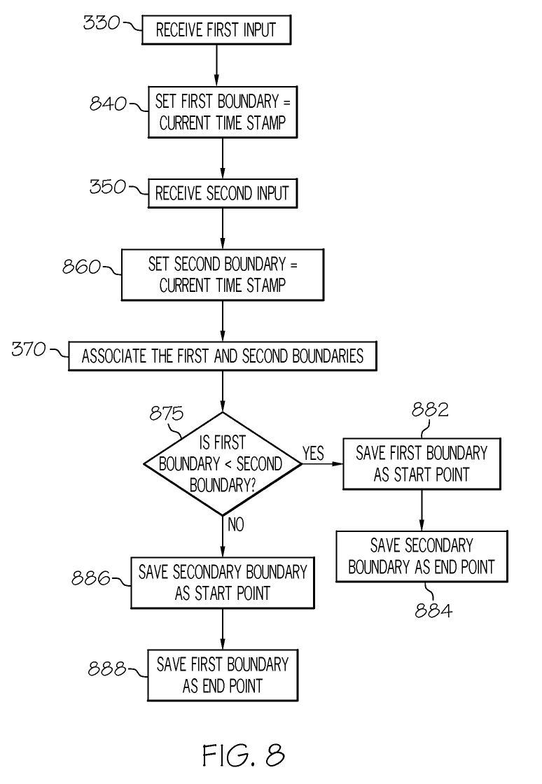

FIG. 7 illustrates an exemplary embodiment in which images or image digest are captured to identify first and second boundaries. In the illustrated example, the start point is determined by querying the user, however the start point may alternatively be determined by comparison of frame numbers or time stamps which would then need to be captured with the images or digests. In this exemplary embodiment, the images or digests of the images from one or more frames being displayed when the first input is received and in response to receiving the first input are captured as a first boundary (step 740). As described previously, images may be digital representations of a single frame or single refresh cycle of a streaming video signal. Digests may be truncated or reduced versions of the images comprising for example, fewer pixels.

The application queries the user on whether or not the first boundary is a start point for censoring (step 745). If so the first boundary images or digests are saved as a start point (step 781). If not, then the first boundary images or digests are saved as an end point for censoring (step 782). The start point and end point images or digests together with substitute content may be saved to a censoring file which can be stored and shared independently of the program content. For example, censoring files may be saved and distributed on a web site for parent interaction or other groups that might be interested in sharing censoring definitions for program content.

Similarly, a second input is received (step 350) and in response a second boundary is identified by capturing images or digests for one or more frames or the like (step 760). The first and second boundaries are associated as a boundary pair (step 370) and a determination is made of whether or not the previous boundary was the start point (step 375). If so, then the second boundary is saved as an end point (step 783). If not, then the second boundary is saved as a start point (step 784).

FIG. 8 illustrates an exemplary embodiment of the invention in which the first and second boundaries are time stamps. In this embodiment a time stamp is provided in a media stream or by a clock within or external to the audiovisual device, representing for example the time that the content was originally broadcast. In response to receiving a first input (step 330), the application sets a first boundary as the current time stamp (step 840). In response to receiving a second input (step 350), the application sets a second boundary as the current time stamp (step 860). The first and second boundaries are associated (step 370) to form a boundary pair and the boundaries are compared (step 875) to determine which is the earlier time stamp. If the first boundary is an earlier time stamp, then the first boundary is saved as a start point (step 882) and the second boundary is saved as an end point (step 884). If the second boundary is an earlier time stamp, then the second boundary is saved as a start point (step 886) and the first boundary is saved as an end point (step 888).

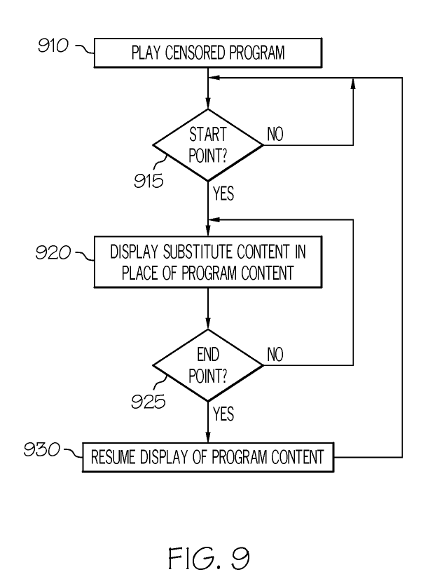

FIG. 9 illustrates a method for selectively displaying substitute content in place of censored program content while playing a program of audio, video or audiovisual content according to an exemplary embodiment of the invention. An apparatus or system initiates play of a censored program (step 910). This may be accomplished, for example, by a user providing a play command through a remote control or other user interface to a device adapted to play programs such as a DVR, CD player, distributed network program provider, or the like. In an exemplary embodiment, the user downloads the censored program over a network either onto a media suitable for playing in an audiovisual playing device or directly into the audiovisual playing device.

While the program is playing, an apparatus or system executes an application for censoring programs, and the application checks each frame for start censoring metadata (step 915). If the frame does not contain the start censoring metadata, the program continues to play and the application continues to search for the start metadata. If the frame does contain the start metadata, then the application causes the program playing apparatus to display substitute content associated with the start point in place of the censored program content (step 920). The program continues to play even though it is not being displayed and the application begins checking each frame for end censoring metadata (step 925). If a frame does not have the end censoring metadata inserted onto it, then the application continues to display the substitute content (step 920) and check the next frame for the end censoring metadata (step 925).

If the current frame does contain the start censoring metadata in step 925, then the program resumes displaying the program content (step 930), and the application again searches each frame for start censoring metadata (step 915). Thus, the program content is played to the end of the program with a variable number of portions of program content being censored so that substitute content is displayed in place of the censored content.

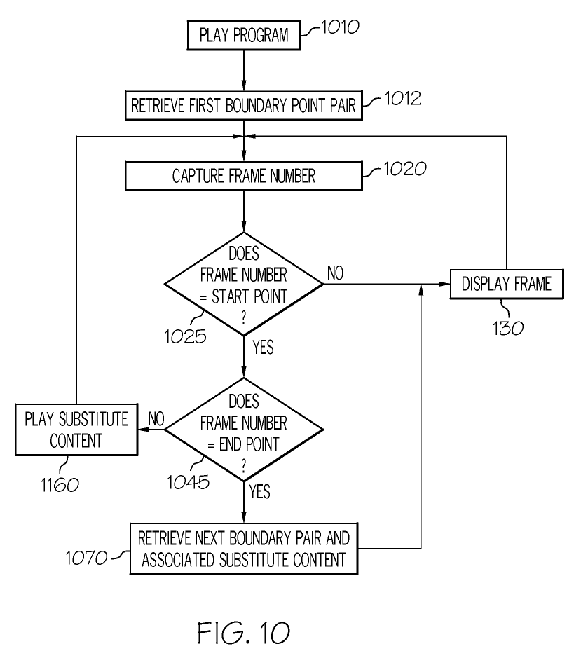

FIG. 10 illustrates an alternate method for selectively displaying substitute content in place of censored program content while playing a program of audio, video or audiovisual content according to an exemplary embodiment of the invention. As with the method of FIG. 9, an apparatus or system begins playing a program (step 1010). This step of beginning to play the program may be performed by the processor 130, 231 of FIGS. 1 and 2 respectively or independently of the processor. Moreover, the step of beginning to play a program may include determining and/or retrieving a censoring file.

The application then retrieves a first boundary point pair (i.e. a start point and end point that define the first portion of censored content) (step 1012). A substitute content associated with this censored content is also retrieved with the first boundary point pair. The boundary point pair and substitute content may be stored, for example, in RAM operatively connected to a processor executing the censoring application.

If the censoring boundaries and start and end points are frame numbers, then an application executed by the processor 130 or 231, captures each frame number as that frame is displayed (step 1020). Similarly, if the boundaries and start and end points are time stamps, then a time stamp is captured, and if the boundaries and start and end points are images or digests, then an image is captured for each frame. The following description will be directed to frame numbers, however, it should be understood that these other boundary point forms could be used in place of frame numbers.

The application compares the captured attribute (e.g., frame number, time stamp, image, digest, etc) to the saved start point (step 1025). For example if the attribute is frame numbers as illustrated in FIG. 10, the application compares the current captured frame number to the frame number or frame numbers saved as start points. If the current captured frame number does not meet the test criteria, the application displays the current frame of the program (step 130). In the illustrated example, if the current frame number is not greater than or equal to the frame number for the start point of the currently retrieved boundary pair, the test criteria is not met, and the frame is displayed.

If the current frame number does meet the test criteria (in the illustrated example, the frame number would be greater than or equal to the frame number stored as the start point in the censoring file), then the application determines whether or not the current frame number meets the end point criteria (step 1045). If the current frame number does not match the end point, then the application causes the apparatus or system to display substitute content (step 1060). This may be accomplished, for example, by switching the output to the display and/or speakers from the censored program content to a substitute content from a downloaded censoring file. Thus, in this embodiment although the current frame is played (i.e. the program content continues to be sent from the drive 110 or data stream 2B), the application does not send this signal to the display and/or speakers, but rather sends a signal comprising the substitute content to the display/speakers. In this embodiment the application continues to capture each frame number (step 1020) and compares the captured frame number (step 1025). Alternatively, the application may, in response to an attribute corresponding to the start point, display the substitute content. Then following display of the substitute content, skip to the end point for the program. Thus, in this embodiment, the censored content is not played.

If, in step 1045, the captured frame number meets the end point criteria, then the application retrieves the next boundary pair and associated substitute content from the censoring file (step 1070). The application also causes the program playing apparatus or system to display the program content (step 1030). That is, the current frame is displayed on a display, such as a television, speaker set, etc., and the application goes back to capturing frame numbers (step 1020) and comparing them to saved start points (step 1025).

If the censoring boundaries and the start and end points are time stamps, then the application compares the captured current time stamp to the saved start point time stamp. When a match is found the associated substitute content is displayed in place of the current frame of content. As long as the current frame matches the start point criteria and not the end point criteria, the substitute content is displayed. Similarly, if the start point is an image or digest of one or more frames of content, then the application captures the current image or digest for one or more current frames and compares the captured images/digests to the saved start point. The comparison may use any of a number of known image matching methods. Again upon a match, the application displays substitute content associated with the boundary pair. The application continues capturing attribute data (e.g., images/digests) and comparing them to the saved start and end point images/digests. When the end point criteria is met, the application retrieves the next boundary pair, displays the current program frame, captures each frame and compares it to the new start and end points.

Alternatively, the application may determine whether or not the current attribute is within the boundaries of the current censored area. If not, then the application displays the current frame of the program (step 130). If the current attribute is within the boundaries of the current censored area, then the application displays the substitute content. After the substitute content is displayed, the application displays the program from the end point of the current boundary pair and retrieves the next boundary pair and any associated substitute content.

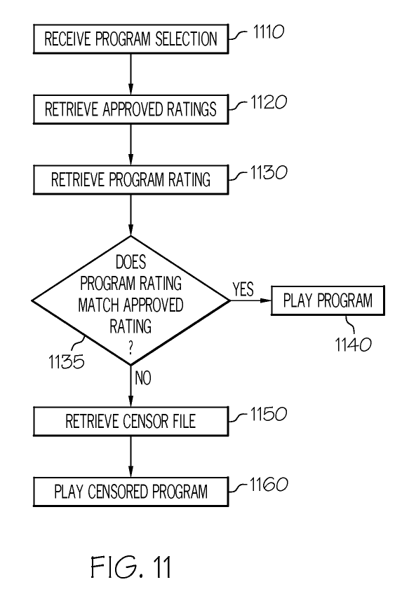

FIG. 11 is a flow diagram showing an implementation of the invention retrieving censoring information according to an exemplary embodiment of the invention. In this embodiment, an application executing on a processor receives a program selection (step 1110). This may be accomplished, for example, by receiving a user input from a remote control to select or to play a program from a recorded memory or from a data stream, or the like. In this exemplary embodiment, the program is encoded with a rating, providing information about the content of the program, such as the presence of violence, sex, adult themes etc, or providing an age for which the content may be appropriate or a combination thereof. Moreover, in this exemplary embodiment, the system or apparatus is programmed with an approved rating level. For example, an approved rating level may be selected from a menu or a dialog box or the like. Additional levels may also be selected that require a password or access code.

The application retrieves the approved rating (step 1120) and retrieves the program rating (step 1130). The application compares the approved rating to the program rating (step 1135). If the approved rating meets or exceeds the program rating, then the application allows the program to play uncensored (step 1140). If the program rating exceeds the approved rating, then the application retrieves a censor file (step 1150) and plays the censored program. That is, the program is played, and the substitute content is displayed in place of the censored content defined by boundary pairs.

In another exemplary embodiment the start and end point pairs and the substitute content are embedded in an interactive program guide. Thus, when a user selects a program from a program guide, a menu of censoring files is presented to the user. If the user selects one of the censoring files, the censored program is displayed. Alternatively, the user may pre-select a censoring file source such as a specific on-line parent group web site from a program guide. The user may then program a DVR device to record selected programs from the program guide. The application will then retrieve censoring files for the selected programs from the selected source and record the selected programs. The programs are not made available for viewing until the program is recorded and the censoring file is downloaded. When the program is viewed, the substitute content from the censoring file is displayed in place of the censored content.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain, store, communicate, propagate, or transport the program for use by or in connection with the instruction execution system, apparatus, or device.

The foregoing method may be realized by a program product comprising a machine-readable media having a machine-executable program of instructions, which when executed by a machine, such as a computer, performs the steps of the method. This program product may be stored on any of a variety of known machine-readable media, including but not limited to compact discs, floppy discs, USB memory devices, and the like. Moreover, the program product may be in the form of a machine readable transmission such as blue ray, HTML, XML, or the like.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

The foregoing drawing figures and descriptions are for illustrative purposes and are not intended as limitations. Rather variations and combinations of the features are intended within the scope of the invention.

What is claimed is:

1. A method for selectively replacing recorded program content while displaying a program, the method comprising the steps of:
in response to a first input, identifying a first boundary;
in response to a second input, identifying a second boundary;
providing substitute content and
displaying the substitute content instead of the program content between the first boundary and the second boundary.

2. The method of claim 1 further comprising the steps of:
in response to a third input, identifying a third boundary;
in response to a fourth input, identifying a fourth boundary;
providing second substitute content; and
replacing the content between the third censoring boundary and the fourth censoring boundary with the second substitute content.

3. The method of claim 1, wherein the substitute content is retrieved over a network connection.

4. The method of claim 1, wherein the substitute content is embedded or referenced in a multimedia stream of the program.

5. The method of claim 1, wherein the substitute content is embedded or referenced in an interactive program guide.

6. A method for displaying a program with substitute content, comprising the steps of:
retrieving censoring start and end point pairs and substitute content or substitute content references for a program;
playing the program;
in response to reaching each start point, displaying substitute content; and
after displaying the substitute content resume displaying the program at the end point.

7. The method of claim 6, wherein the start and end point pairs and the substitute content are saved in a censoring file accessible over a network.

8. The method of claim 6, wherein the start and end point pairs and the substitute content are embedded in a multimedia stream containing the program.

9. The method of claim 6, wherein the start and end point pairs and the substitute content are embedded in an interactive program guide.

10. The method of claim 6, further comprising the step of:
receiving an acceptable program rating input; and
wherein the retrieving step comprises retrieving censoring start and end point pairs and substitute content or substitute content references associated with the acceptable rating.

11. The method of claim 10, further comprising the steps of:
comparing the acceptable rating to a rating for a requested program;
requesting a password if the rating for the requested program exceeds the acceptable rating; and
retrieving censoring start and end point pairs and substitute content or substitute content references associated with the acceptable rating if the password is not entered.

12. The method of claim 6, wherein the substitute content comprises at least one of: plain text, MP3 files, or graphic files.

13. An apparatus for displaying programs with substitute content displayed in place of censored content, the apparatus comprising:
a processor adapted to execute a program of instructions;
a memory operably interconnected with the processor;
a means for receiving audiovisual program content;
a means for retrieving a censoring file comprising boundary pairs and associated substitute content; and
a program of instruction encoded on the memory and executable by the processor to perform the steps of: playing a program; in response to a start point of a boundary pair, displaying associated substitute content; and after displaying the substitute content resuming display of program content at an end point of the boundary pair.

14. The apparatus of claim 13, wherein the processor, and the memories are located in a digital video recording device.

15. The apparatus of claim 13, wherein the processor, and at least one memory are available through a distributed network.

26. A machine program product comprising a machine readable media having encoded thereon:
a first program instruction to play a program;
a second program instruction to identify a first boundary in response to a first input;
a third program instruction to identify a second boundary in response to a second input;
a fourth program instruction to associate the first censoring boundary with the second censoring boundary; and
a fifth program instruction to censor the content between the first boundary and the second boundary.

17. A machine program product comprising a machine readable media having encoded thereon:
identification of boundary pairs defining censored program content there between and associated substitute content; the boundary pairs comprising a start point adapted to cause a program playing device to display the substitute content in place of censored program content and an end point adapted to cause a program playing device to resume displaying content of the program.

18. The machine program product of claim 17, wherein the identification of a start point and the identification of an end point comprise metadata inserted in the program at frames corresponding to the start point and the end point.

19. The machine program product of claim 17, wherein the identification of a start point and the identification of an end point comprise one or more images or image digests; and the machine program product uses an image matching application to locate the start point and the end point for censoring.
